(19) United States
(12) Patent Application Publication
(10) Pub. No.: US 2021/0219535 A1
(43) Pub. Date: Jul. 22, 2021

(54) AN ECO-FRIENDLY MOSQUITO CONTROL SYSTEM

(71) Applicants: Anastasiia Romanivna ROMANOVA, Kherson (UA); Andriy Valeriyovych MUSHAKOV, Kherson (UA)

(72) Inventors: Anastasiia Romanivna ROMANOVA, Kherson (UA); Andriy Valeriyovych MUSHAKOV, Kherson (UA)

(21) Appl. No.: 17/265,183

(22) PCT Filed: Nov. 26, 2018
(86) PCT No.: PCT/UA2018/000126

§ 371 Date: Feb. 1, 2021

(30) Foreign Application Priority Data
Aug. 1, 2018 (UA) A 2018 08394

(51) Int. Cl. A01M 1/02; A01M 1/08

(52) U.S. Cl. CPC A01M 1/023; A01M 1/08

(57) ABSTRACT

A device for controlling harmful insects. The device includes a case, a container for collecting insects, service doors, wheels bracket, wheels, a decorative cover, a fan with a protective grid, electronic elements, an odorant reservoir, a CO2 cylinder, a control panel with a screen, a protective grid, an interactive panel, solar battery elements, LTE/GSM modules, a panoramic camera, a nozzle for spraying gas mixture and vapor, light emitters, Wi-Fi module, mounting for municipal lamp posts. The invention provides increased device characteristics for luring insects due to the complex interaction of all attractive components, as well as improving the performance of the device.

### CROSS-REFERENCE TO RELATED APPLICATIONS

This application claims priority under 35 U.S.C. Section 371 to the International Application No. PCT/2018/000126, filed Nov. 26, 2018, and to the Ukranian Application No. UA/a201808394, filed Aug. 1, 2018, now pending, the contents of which are hereby incorporated by reference.

### TECHNICAL FIELD

The present disclosure relates generally to a system and method that reduce the population of insects in an open area by means of attracting, trapping and extermination.

### BACKGROUND

Traditionally, a method of attracting blood-sucking arthropods, especially insects and arachnids, as they are particularly attracted by CO2. Arthropods can be captured and kept and/or killed in a catching device. At least one liquid or solid organic material reacts to the oxidation process for CO2 formation. In particular, the term “organic matter” is used to describe an organic substance or a mixture of organic compounds.

According to this method, in the process of oxidation the substance reacts as follows: one part of the substance is completely oxidized, and the other part is oxidized partially. The product of partial oxidation increases the specific effect of the attractant mixture. Also, the heat generated during the oxidation process is another positive factor in attracting insects. (See, for example, U.S. Pat. No. 9,192,165 (B2) dated Nov. 24, 2015).

Here, the mosquito device consists of a case, a heater, a fan, a grating, and means for spreading of volatile attractant. The case has a coating that imitates human skin. Gratings are fixed between the three flanges. Means for spreading of volatile attractant are made in the form of a container with carbon dioxide and a CO2 regulator.

In another case, a container is connected to the outlet of the CO2 regulator. The container has a replaceable cartridge with Octenol (See, for example, RU patent 2482673 dated May 27, 2013).

However, the disadvantages of the given device are limited operation coverage on the territory, vulnerability to external influences, the need for constant human participation in device maintenance services.

### SUMMARY

The object of the disclosed embodiments is to improve device characteristics for attracting insects by means of complex interaction of all attractive components, as well as improving the operational qualities of the device.

To solve the problem, the ecological mosquito control system including a case, a heater, a fan, a net and means for spreading of volatile attractant, additionally contains light emitters, a nozzle for spraying gas mixture and vapor, a container for odorant, a control panel with a screen, protective grids, solar panel elements, wheel, unit of electronic elements, an interactive panel, a panoramic camera, LTE/GSM and Wi-Fi modules. The trap has a main housing, an internal CO2 system, a high-strength metal enclosure, protected from atmospheric influences, high suction power, which allow for increased operating range of the trap, compared to the analogues. Internal processor and remote-control system allow for controlling of the devices connected to the ecosystem.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows a perspective view of the system.

FIG. 2 shows the general view of the system in parts.

### DETAILED DESCRIPTION

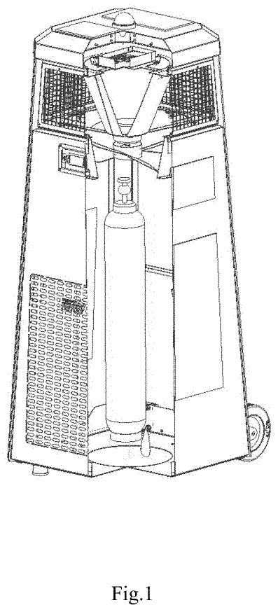

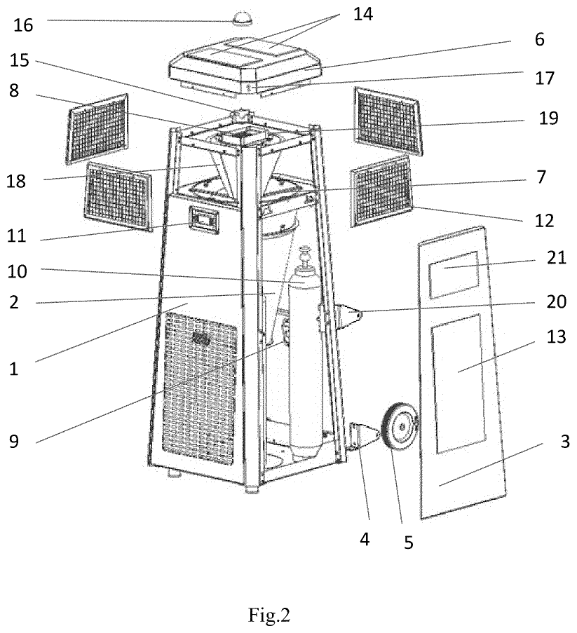

The disclosed embodiments as described by FIGS. 1 and 2. relate to an ecological mosquito control system for public areas, which has a case, a container for collecting insects 2, service doors 3, wheels bracket 4, wheels 5, a decorative cover 6, a fan with a protective mesh 7, a unit of electronic elements 8, an odorant reservoir 9, a CO2 cylinder 10, a control panel with a screen 11, a protective net 12, interactive panel 13, solar battery elements 14, LTE/GSM modules 15, panoramic camera 16, a nozzle for spraying gas mixture and vapor 17, light emitters 18, Wi-Fi module 19, mounting for municipal lamp posts 20, a heating element 21.

The device works as follows: immediately after the device is turned on, electronic elements 8 in a certain sequence start operating and light emitters 18 are switching on. Following the release of the natural gas—pre-saturated with odorant, attractant lures insects that are caught by the air stream, which catches insects and moves those into a container for keeping and disposal.

The insects are attracted by simulating the processes of human and animal life, which may include the allocation of heat, carbon dioxide, odor, and imitation of breathing. Light, sound effects, and vapor separation are also used to lure insects. The electromechanical control system is based on the principle of attracting insects, catching and destroying those to reduce the population in certain areas. Insects, following their instincts while searching for food, are lured to a device simulating a living organism, emitting heat, carbon dioxide, odor, steam, and light.

The system is absolutely safe and environmentally neutral due to the metal case.

The device can be connected to the unlimited number of systems with a single control center through communication channels that might control large ecosystems/be connected to Smart devices.

Sensors and software provide maximum performance of the device depending on the climate, time of day and meteorological conditions. The device is intended for use in large areas—ecosystems, and can be mounted on municipal lamp posts due to specialized fastening.

The unit has an option of autonomous power supply from solar panels that, along with energy accumulator allows for carrying out of military operations and use of the device in places with no access to the network.

The system for monitoring of the environment can be integrated optionally.

The device is equipped with data and information transmission system, the data being received from the Internet from the operator and distributed via Wi-Fi. The device is provided for the installation of advertising panels. The technical solution offered is aimed at increase of device characteristics for luring insects due to the complex interaction of all attractive components, and improving the operational qualities of the device.

What is claimed is:

1. An ecological mosquito control system, comprising:
a case;
a heater;
a fan;
a protective mesh; and
means for spreading a volatile attractant, wherein the means for spreading the volatile attractant further includes:
light emitters; a nozzle for spraying gas mixture and vapor;
a container for odorant;
a control panel with a screen;
a protective net;
solar panel elements;
wheels;
a unit of electronic elements;
an interactive panel; a panoramic camera;
an LTE/GSM and Wi-Fi modules; and
a mounting for municipal lamp posts.
